(19) United States
(12) Patent Application Publication
(10) Pub. No.: US 2006/0226783 A1
(43) Pub. Date: Oct. 12, 2006

(54) Krypton metal halide lamps

(76) Inventors: Abbas Lamouri, Aurora, OH (US); Juris Sulcs, Chagrin Falls, OH (US)

Correspondence Address: DUANE MORRIS LLP, Suite 700, 1667 K Street, N.W., Washington, DC, 20006, US

(21) Appl. No.: 11/179,654

(22) Filed: Jul. 13, 2005

Related U.S. Application Data
(60) Provisional application No. 60/669,380, filed on Apr. 8, 2005.
(60) Provisional application No. 60/587,048, filed on Jul. 13, 2004.

(51) Int. Cl. H01J 17/20

(52) U.S. Cl. 313/637

(57) ABSTRACT

The present application discloses an arc tube for a metal halide lamp having a fill gas pressure sufficient for providing sufficient impedance for rapid warm-up of the light source after ignition. The fill gas consists essentially of krypton or comprises a mixture of krypton with xenon or argon, or both.

### CLAIM OF PRIORITY

This application claims the benefit of U.S. Provisional Application Nos. 60/669,380 and 60/587,048, the disclosures of which are hereby incorporated by reference.

### BACKGROUND OF THE INVENTION

The present invention relates to metal halide lamps. More particularly, the present invention relates to metal halide lamps having a fill gas comprising krypton at a pressure greater than about one-half atmosphere.

Compact metal halide light sources have found widespread use in fiber optic lighting systems, projection displays, and automotive headlamp applications. These metal halide lamps have been favored in such applications because of the very rapid warm-up, smaller size relative to halogen light sources, relatively long life, and high efficiency in producing white light of such light sources.

The very rapid warm-up of these light sources provides for substantially immediate light output, which is a requirement in many applications, is possible because of the presence of a high fill pressure of xenon in the arc tube chamber at room temperature. When a high-pressure xenon light source is initially energized, the xenon contained within the arc tube is excited and produces some light immediately. Almost immediately following ionization of the xenon atoms, the mercury and halide salts are vaporized. The vaporization of mercury and halides enhances the light output as well as the efficiency of these light sources. A typical warm-up curve of a commercially available high pressure xenon metal halide light source is illustrated in FIG. 1.

U.S. Pat. Nos. 5,221,876 and 5,059.865 disclose a metal halide light source having xenon at a pressure at room temperature in the range between two and fifteen atmospheres and sufficient starting current to excite the xenon to produce a significant amount of light during the first few seconds of lamp operation. After a few seconds have expired, the light output from the xenon is augmented by the light output from the mercury and metal halide for sustained light output.

The disadvantage associated with high pressure xenon metal halide light sources is that xenon is fairly costly, adding to the overall cost of the lamp. While the amount of xenon contained in the arc tube is relatively small, the amount which is wasted in the arc tube manufacturing process is not insignificant and varies greatly depending on the method used to fabricate the xenon metal halide light sources.

One embodiment of the present invention avoids the problems of the prior art by providing a metal halide lamp having a fill gas comprising krypton or a mixture of krypton with a small amount of xenon or argon, or both.

According to one aspect of the present invention, a novel metal halide light source with very rapid warm-up capability is disclosed. The metal halide light source includes a fill gas comprising krypton or a mixture of krypton with a small amount of xenon or argon, or both. The amount of fill gas provides high impedance so that the lamp immediately begins to heat upon excitation of the gas. As a result of the very rapid heating of the lamp, the mercury and metal halide are quickly ionized and vaporized so that the light output from the excitation of the fill gas is almost immediately augmented by the light output from the mercury and metal halide.

The amount of fill gas is typically selected to obtain a super-atmospheric pressure of fill gas in the arc tube. The light sources typically include a fill gas pressure of about six atmospheres at room temperature, but the fill gas pressure may be as low as one-half atmosphere or as high as one hundred atmospheres as required by the specific application of the light source. The fill gas may consist essentially of krypton, or it may also include argon or xenon at pressures at room temperature not greater than about 2 atm.

The boiling temperature of krypton is −157° C. and thus krypton can be frozen in the arc tube chamber at liquid nitrogen temperature. One advantage of using krypton as the fill gas is that it krypton is five times less costly than xenon.

The objects and advantages of the present invention will be readily apparent to one skilled in the art to which the invention pertains from a perusal of the claims, the appended drawings, and the following detailed description of the embodiments.

### BRIEF DESCRIPTION OF THE DRAWINGS

FIG. 1 is an illustration showing the light output vs. time from a prior art xenon metal halide lamp.

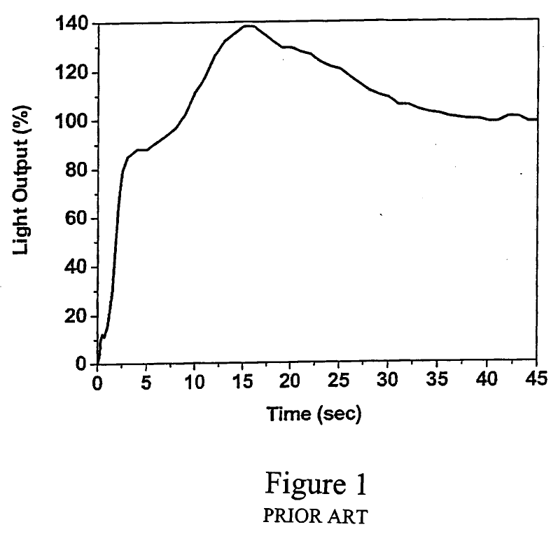

FIG. 2 is an illustration of a metal halide arc tube according to one aspect of the present invention.

FIG. 3 is an illustration showing the light output vs. time from a metal halide lamp according to one aspect of the present invention.

### DESCRIPTION OF PREFERRED EMBODIMENTS

With reference to the drawings, like numerals represent like components throughout the several drawings.

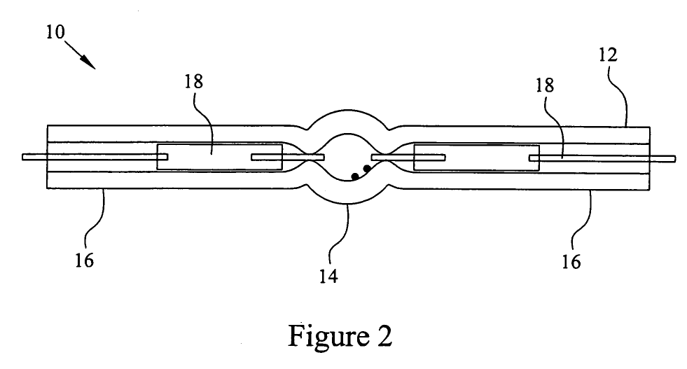

FIG. 2 illustrates a metal halide arc tube according to one aspect of the present invention. Although FIG. 2 illustrates a quartz formed-body arc tube having opposing electrodes, the present invention also applies to arc tubes having the electrodes positioned in a single end portion.

With reference to FIG. 2, the arc tube 10 comprises a quartz arc tube body 12 having a bulbous light-emitting chamber 14 intermediate tubular end portions 16. An electrode lead assembly 18 is pinch sealed in each end portion thereby fixing the position of each assembly 18 in the respective end portion 16 and hermetically sealing the chamber 14.

Typically, the chamber 14 is dosed with halides of metals such as sodium, scandium, thorium, thallium, indium, neodymium, or rare earth halides such as dysprosium, holmium, and thulium. The chamber 14 may also be dosed with additional metals such as scandium and cadmium. The chamber 14 also contains mercury and an inert fill gas of krypton or a mixture of krypton and argon. The mercury weight is chosen so that for a given arc tube volume and electrode gap, the arc tube voltage is compatible with existing commercial ballasts. The chamber contains fill gas at a pressure in the range of about one-half to about one hundred atmospheres at room temperature.

For automotive headlamp applications, for example, the preferred halide mixtures consist of iodides of sodium, scandium, and thorium with a weight ratio of 77:21:2 or iodides of dysprosium, neodymium, and cesium with a weight ration of 40:50:10. The weight of the halide dose is typically in the range of about 0.1 to about 1.0 mg. The volume of the chamber is about 30 μl, the arc gap is about 4 mm, and the mercury dose is about 0.5 mg. The resulting operating voltage on commercially available ballasts is approximately 85 volts. A fill pressure of about 4-10 atmospheres is desirable in order to obtain sufficient instant light and impedance and avoid excessive internal volume pressures during normal operation when the mercury and halides are fully vaporized. The fill gas may consist essentially of krypton or may be a mixture of krypton with argon or xenon with the xenon pressure at room temperature no greater than about 2 atm.

Some examples include a fill gas consisting essentially of krypton at pressures at room temperature between about 0.5 atm. and 100 atm., and preferably between about 4 atm. And about 10 atm. In one embodiment, the fill gas consists essentially of krypton at a pressure at room temperature of 6 atm. In another embodiment, the fill gas includes krypton at a pressure in the range of about 4 atm. to about 10 atm., and xenon at a pressure in the range of about 1.5 atm. to about 1.0 atm. In yet another embodiment, the fill gas includes krypton at a pressure in the range of about 4 atm. to about 10 atm. and argon at a pressure in the range of about 0.5 atm. to about 1.0 atm.

The light source of the present invention may be made using existing methods capable of making light sources with super-atmospheric fill pressure. Examples of such methods are described in U.S. Pat. No. 5,108,333 by Heider et al. and in U.S. Pat. No. 6,517,404 by Lamouri et al. The light sources may also be made by the methods disclosed in co-pending U.S. patent application Ser. No. ______ entitled “HIGH INTENSITY DISCHARGE LAMPS, ARC TUBES, AND METHODS OF MANUFACTURE” filed Jul. 13, 2005.

In order to obtain a fill pressure of greater than 1 atmosphere at room temperature, it is preferred to cool the arc tube by liquid nitrogen to temperatures below −157° C. during the final pinch process. The advantage of using krypton over xenon is that krypton is five times less costly than xenon and provides as much if not more instant light and impedance for rapid warm-up of the light source after ignition.

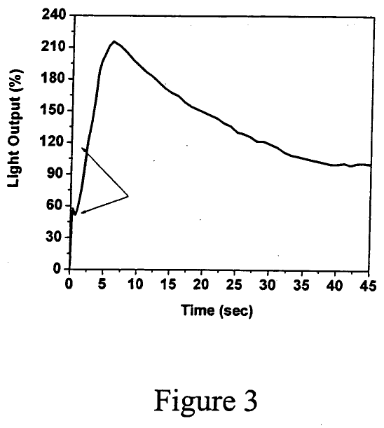

FIG. 3 illustrates the light output over time for metal halide light source according to one aspect of the present invention. The light output illustrated in FIG. 3 was measured from a metal halide lamp having a fill gas consisting essentially of krypton at a pressure of about 8.0 atmospheres at substantially room temperature.

While preferred embodiments of the present invention have been described, it is to be understood that the embodiments described are illustrative only and that the scope of the invention is to be defined solely by the appended claims when accorded a full range of equivalence, many variations and modifications naturally occurring to those of skill in the art from a perusal hereof.

What is claimed is:

1. An arc tube for a high intensity discharge lamp comprising:
an arc tube body having a chamber intermediate two end portions;
an electrode lead assembly sealed in each end portion;
a lamp fill contained within said chamber comprising mercury and one or more metal halides; and
krypton contained within said chamber at a pressure at substantially room temperature in the range of about 0.5 atmospheres to about 100 atmospheres.

2. The arc tube of claim 1 wherein the pressure of the krypton is in the range of about 2.0 atmospheres to about 20 atmospheres.

3. The arc tube of claim 2 wherein the pressure of the krypton is in the range of about 4.0 atmospheres to about 10 atmospheres.

4. The arc tube of claim 3 further comprising xenon contained within said chamber at a pressure at substantially room temperature no greater than 2.0 atmospheres.

5. The arc tube of claim 4 wherein the pressure of the xenon is in the range of about 0.5 atmospheres to about 1.5 atmospheres.

6. The arc tube of claim 3 further comprising argon contained within said chamber at a pressure at substantially room temperature no greater than 2.0 atmospheres.

7. The arc tube of claim 6 wherein the pressure of the argon is in the range of about 0.5 atmospheres to about 1.5 atmospheres.

8. The arc tube of claim 1 wherein said arc tube body is formed from quartz.

9. The arc tube of claim 1 wherein the metal halides comprise iodides of sodium, scandium and thorium or iodides of dysprosium, holmium, and thulium.

10. An arc tube comprising a hermetically sealed chamber containing one or more metal halides and krypton at a pressure at substantially room temperature greater than about 1.0 atmospheres.

11. The arc tube of claim 10 wherein the pressure of the krypton is greater than about 4.0 atmospheres.

12. The arc tube of claim 11 wherein the pressure of the krypton is between about 4.0 atmospheres and about 10 atmospheres.

13. The arc tube of claim 12 wherein the metal halides comprise iodides of sodium, scandium and thorium.

14. The arc tube of claim 13 wherein the weight ratio of the iodides of sodium, scandium is 77:21:2.

15. The arc tube of claim 11 wherein the metal halides comprise iodides of dysprosium, holmium, and thulium.

16. The arc tube of claim 15 wherein the weight ratio of the iodides of dysprosium, holmium, and thulium is 40:50:10.
